(19) United States
(12) Patent Application Publication
(10) Pub. No.: US 2016/0272368 A1
(43) Pub. Date: Sep. 22, 2016

(54) BOTTLE INTERLOCK

(71) Applicant: VariBlend Dual Dispensing Systems LLC, Greenville, SC (US)

(72) Inventor: Carl Edward Buck, III, Greenville, SC (US)

(21) Appl. No.: 15/071,363

(22) Filed: Mar. 16, 2016

Related U.S. Application Data
(60) Provisional application No. 62/135,788, filed on Mar. 20, 2015.

(51) Int. Cl. B65D 21/02; B05B 11/00; B65D 1/02

(52) U.S. Cl. CPC B65D 21/0204; B65D 1/0223; B05B 11/3081; B65D 2501/0081

(57) ABSTRACT

A bottle interlock assembly is provided in which the bottles remain connected together during any striking in any axial orientation. The bottles may be separated and reassembled to refill and/or replace one or both of the bottles. Such a stable bottle connection or interlock assembly preferably has two distinct and different connection assemblies, e.g., a slide and snap. A first interlock connection may include a projection and correspondingly shaped slot to slidingly receive the projection. A second interlock connection may include a protrusion and a correspondingly shaped recess adapted to receive the protrusion or snap together. The first interlock connection prevents the bottles from separating along the x-axis while the second interlock connection prevents the bottles from slidingly separating along the y-axis. The combination of the first and second interlocking connections accurately aligns and keeps the bottles together without the need for additional components.

This application claims priority to U.S. Provisional Application Ser. No. 62/135,788 filed on Mar. 20, 2015, the disclosure of which is incorporated herein by reference in its entirety.

### BACKGROUND

1. Field of the Invention

The present invention relates to a bottle or container interlock. More particularly, the present disclosure relates to a bottle interlock for two bottles or containers associated with a dual dispensing pump or mechanism that allows for accurate alignment during filling and easy replacement of one or both bottles for refill or replacement.

2. Description of the Related Art

It is important when using dual dispensing bottles that are connected to a single pump or actuator mechanism that the two bottles remain positioned contiguous to each other to avoid undue pressure on the actuation mechanism and remain in sealing contact with the actuator mechanism.

Accordingly, there have been attempts to connect two bottles together. For example, German Patent No. DE20218244 discloses the use of a single ‘dovetail’ or sliding connection at the base of the two bottles to connect together the two bottles. The disclosure of German Patent No. DE 20218244 is incorporated herein in its entirety.

There is also a commercial product in which the bottles are connected at both the top and bottom by pairs of interlocking buttons. However, to prevent the bottles from separating, a non-removable base cap is used. Thus, the bottles cannot be separated after the initial assembly.

There are problems with both of the above-mentioned bottle connections should either one of the bottles accidentally strike a surface. For example, for the dovetail connection, it is prone to disassemble from the pump head when accidentally dropped. In particular, if one of the two bottles strikes a hard surface, the second bottle will be caused to easily disengage (axial sliding or y direction) from the pump head and first bottle. Thus, to prevent the two bottles from disconnecting, an additional full adhesive label wrap must be present around both bottles. The use of the label wrap prevents the bottles from being easily refilled or the ability to replace one of the bottles to reuse the pump assembly.

For the commercial button connection, it is sold with a non-removable secondary base cap which prevents the bottles from splitting apart (perpendicular to the axis of the unit or x axis direction) when accidentally dropped on to a hard surface. The non-removable base cap prevents the bottles from being separated for refilling or replacement. Thus, the prior art button connection was not adaptable to allow replacement of a bottle. Similar to the label wrap, the base cap prevents the replacement of the bottles should the product in one bottle be used up before the product in the other bottle.

Thus, there is a need for a bottle interlock that overcomes the shortcomings of the above. In addition, there is a need to do so and also reduce the number of component parts.

### SUMMARY

The present disclosure provides a stable bottle connection or interlock assembly so that even if one of the bottles is dropped, the bottles will remain connected to the pump.

The present disclosure also provides such a stable bottle connection or interlock assembly in which even upon accidental dropping, the bottles remain connected together and, more importantly, connected to the actuator or pump.

The present disclosure further provides such a stable bottle connection or interlock assembly in which the bottles remain connected together during any striking in any axial orientation of either one or both of the bottles.

The present disclosure yet further provides such a stable bottle connection or interlock assembly in which the bottles when connected together provides an improved alignment over the prior art that easily facilitates filling and/or the application of decorative or instructional decor to one or both bottles.

The present disclosure still further provides such a stable bottle connection or interlock assembly having two distinct and different sub-connection assemblies.

The present disclosure yet further provides such a stable bottle connection or interlock assembly having two distinct and different sub-connection assemblies in which the two distinct sub-connection assemblies work in unison so that the bottles do not become disassembled during any accidental axial or rotational movements of either or both of the assembled bottles.

The present disclosure also provides such a stable bottle connection or interlock assembly that prevents the bottles from becoming disassembled during any accidental axial or rotational movements of either or both of the assembled bottles, without the need of any additional components, such as the label wrap or base cap of the prior art, yet provides for the easy disassembly of the bottles for replacement purposes.

A container interlock system formed in accordance with the present invention includes a first and second container, each of the first and second container including a substantially flat back surface. Each of the first and second containers flat back surface preferably includes a first sliding interlock connection provided at one of the bottom and top half of the container. The first sliding interlock connection includes at least one projection and at least one slot adapted to receive the projection. A second interlock connection is provided at a half of the container opposite the first sliding interlock connection. The second interlock connection includes at least one protuberance and at least one correspondingly shaped receiver. The first and second containers are separably connected together by first slidingly engaging the first sliding interlock connection along a longitudinal axis. The protuberances on the first and second containers slide along the flat back surfaces of the containers until aligned with the receiver on the other container for engagement therewith, i.e., a slide and snap connection, thereby providing an interlock connection resisting separation in both the x and y directions.

The at least one slot of the first sliding interlock connection preferably includes an upper portion which is adapted to receive and guide the at least one projection and a lower portion having a complementary shape to the projection to frictionally engage and retain the at least one projection in the lower portion of the at least one slot. The protuberance of the second interlock connection preferably has a geometric shape and the receivers include substantially the same geometric shape to frictionally engage and retain the protuberance therein. The protuberance geometry may be in the form of a circle, a half-circle, a square, a pentagon, a hexagon, an octagon, a triangle or any other known shape by those of ordinary skill in the art. In a preferred embodiment, the first and second containers are identical in structure so that a single mold may be used to make the interlocking containers. The containers preferably include an opening in the top thereof adapted to removably receive a pump mechanism. Thus, the pump mechanism may be removed so that the container may be refilled and/or replaced. In one embodiment, the first and second containers have a semicircular configuration so that when assembled, the containers are substantially cylindrical in shape.

To assemble the containers, the first sliding interlock connection at the bottom of the container allows the containers to separate at an upper end when the sliding interlock connection is engaged to permit the at least one protuberance to slide along the flat surface of the opposite container until aligned with the at least one receiver. The first sliding interlock connection prevents the containers from separating along the x-axis when engaged and the second interlock connection prevents the bottles from sliding along the y-axis when engaged.

A container interlock system formed in accordance with the present invention includes a first and second container, each of the first and second container including a back surface. The first and second containers include identical structure provided on the back surface. A first interlocking connection means is provided on the back surface for separably holding the first and second containers together. The first interlocking connection means is engageable by sliding the first container relative to the second container. A second interlocking connection means is also provided on the back surface for separably holding the first and second containers together. The second interlocking connection means is engageable by fitting or snapping a protuberance into a correspondingly shaped recess adapted to receive the protuberance. The first interlocking connection means prevents separation of the containers along an x-axis and the second interlocking connection means prevents sliding of the containers relative to each other along an y-axis to keep the containers coupled together and accurately aligned. Preferably, the first interlocking connection means comprises a projection adapted to slidingly engage a correspondingly shaped slot. The projection is preferably dovetail-shaped and the slot includes a dovetail-shaped slot to receive the dovetail-shaped projection. The second interlock connection means may include a button having a geometric shape and a correspondingly shaped recess adapted to receive the button. In a preferred embodiment, the first interlock connection means is provided on one of the upper and lower half of the back surface and the second interlock connection means is provided on the opposite half of the back surface from the first interlock connection means. The first interlock connection means and second interlock connection means are adapted to be engageable and separable to allow replacement of one or both the first and second containers. The first and second containers include an opening in the top thereof adapted to removably receive a pump or dispenser mechanism. Preferably, the pump mechanism is a variable ratio dispenser for mixing the products filled in the two containers.

Before the embodiments of the invention are explained in detail with reference to the figures, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### BRIEF DESCRIPTION OF THE DRAWINGS

FIG. 1 is a top perspective view of the two assembled bottles with the bottle interlock assembly according to the present invention.

FIG. 2 is a top view of the two assembled bottles of FIG. 1.

FIG. 3 is a bottom perspective view of the two assembled bottles of FIG. 1 showing internal structure in broken lines.

FIG. 4 is a side view of the two assembled bottles of FIG. 1.

FIG. 5 is a bottom view of the two assembled bottles of FIG. 1.

FIG. 6 is a perspective view of the back of one of the two assembled bottles of FIG. 1.

FIG. 7 is a front plan view of the back shown in FIG. 6.

FIG. 8 is a side view of the bottle shown in FIG. 6.

FIGS. 9A and 9B are schematic views of the two assembled bottles of FIG. 1 illustrating the bottle interlock assembly in broken lines.

FIG. 10 is a side view of the two bottles in a partially assembled state.

FIG. 11 is an exploded view of the bottles and the pump mechanism to remove product from the bottles.

FIG. 12 illustrates the assembled pump mechanism mounted on the assembled bottles.

### DETAILED DESCRIPTION OF THE DISCLOSURE

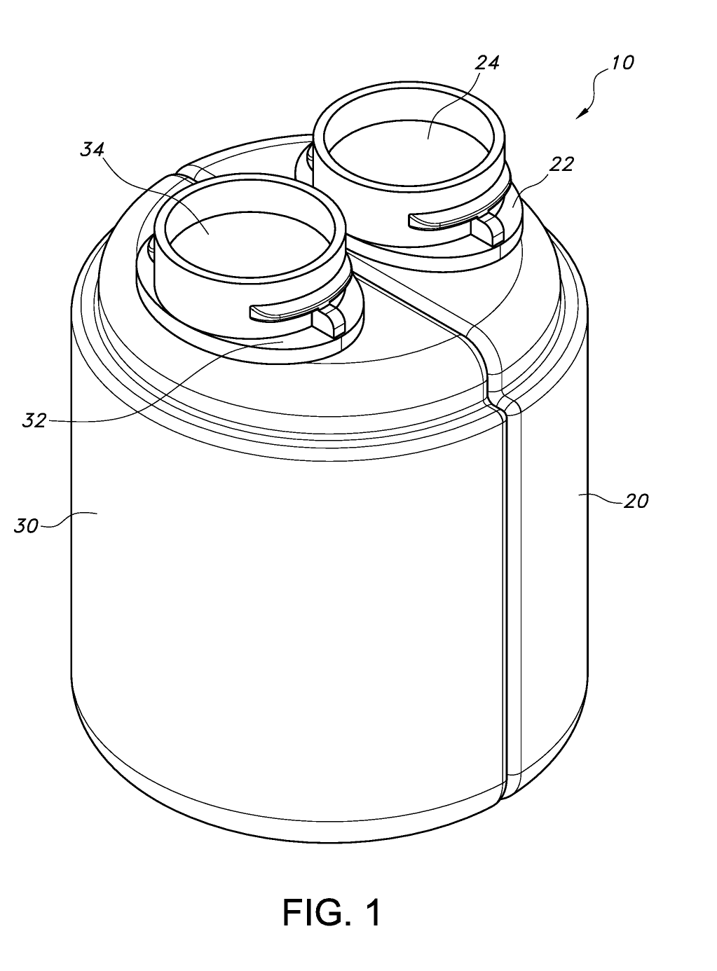

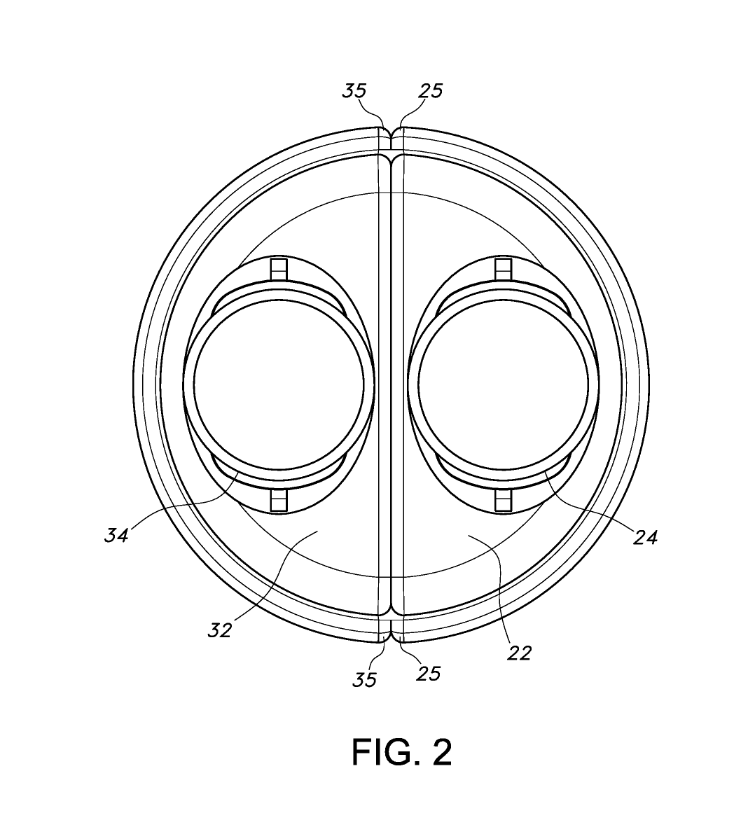

Referring to the drawings and, in particular, FIG. 1, there is shown an assembly of a pair of connected bottles or bottle halves generally represented by reference numeral 10. The pair of bottles or containers 20 and 30 are identical structures as shown in more detail in FIGS. 2 to 8. Thus, a single mold can produce bottles which can be joined together. Each bottle 20, 30 preferably has a semicircular configuration so that when assembled, a substantially circular container is provided.

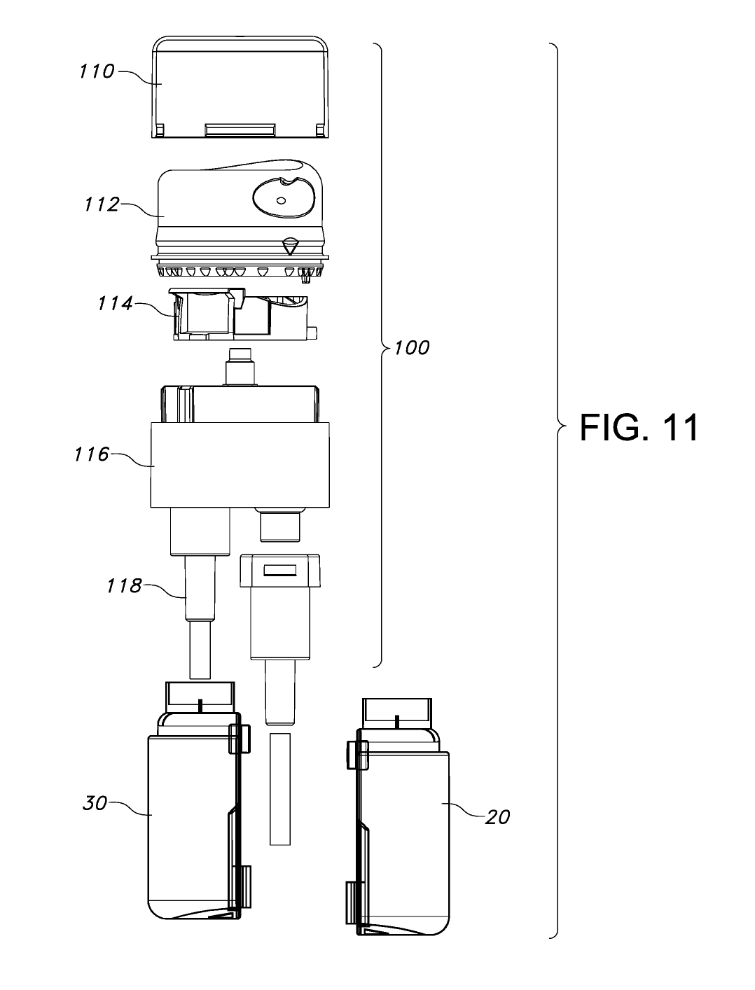

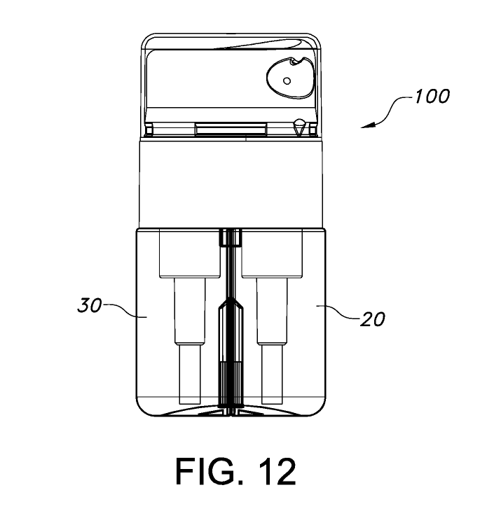

As shown in FIGS. 1 and 2, bottles 20 and 30 have tops 22 and 32, respectively, each with openings 24 and 34, respectively, for connection to an actuator or pump mechanism. See FIGS. 11 and 12). A suitable pump mechanism may be a proportioning dispenser to allow an adjustment of the mixing ratio of substances contained in bottles 20, 30. One such a dosage dispenser pump is disclosed in U.S. Pat. No. 6,464,107, the disclosure of which is incorporated herein in its entirety. Each bottle 20, 30 has chamfered edges 25, 35, respectively, so that the bottles when connected together have a substantially circular appearance.

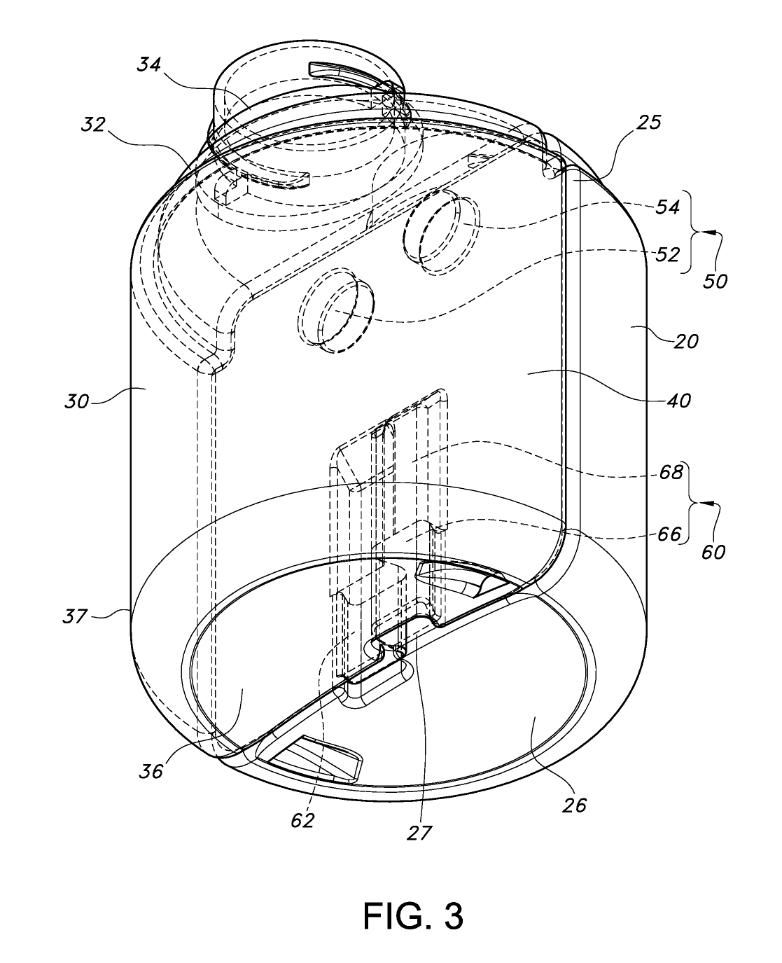

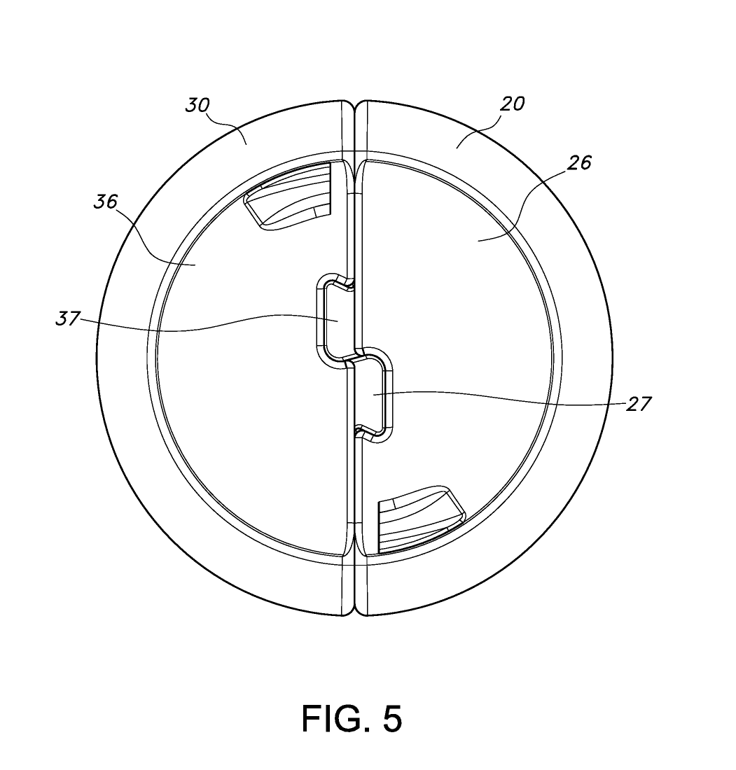

As shown in FIGS. 3 and 5, each bottle 20 and 30 has a bottom surface 26 and 36, respectively. Each bottom surface 26 and 36 has an indentation 27 and 37, respectively. When the two bottles 20 and 30 are connected together the bottom edges of each bottle 20 and 30 touch each other.

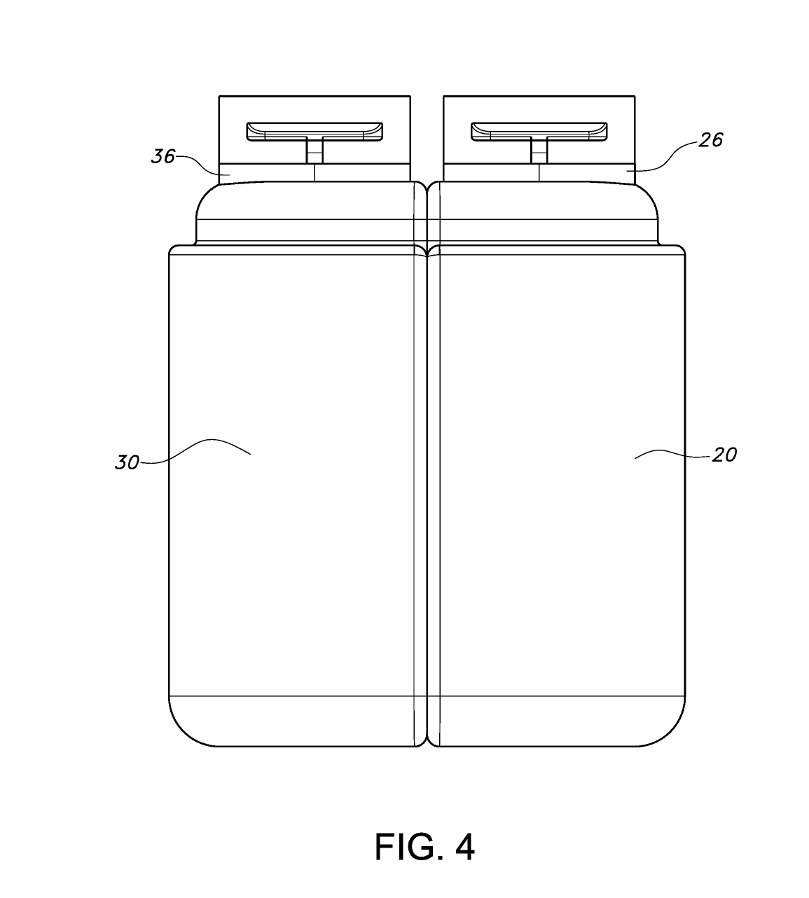

As shown in FIG. 4, when the two bottles 20 and 30 are in position or connected together, the back of each, and thus the chamfered edges, are held together and may touch or contact each other. However, the significant benefit, whether the bottles contact or not, is that a first interlock connection 50 and a second interlock connection 60, discussed in further detail below, ensure alignment of the two bottles in both the x and y axis or planes. This alignment is of significant importance as the two bottles are moved to and through the filling and pump head assembly process. In view of the alignment, filling the bottles is more efficient and the pump head can accurately and more completely align with the opening in the tops 26, 36 of bottles 20 and 30, respectively.

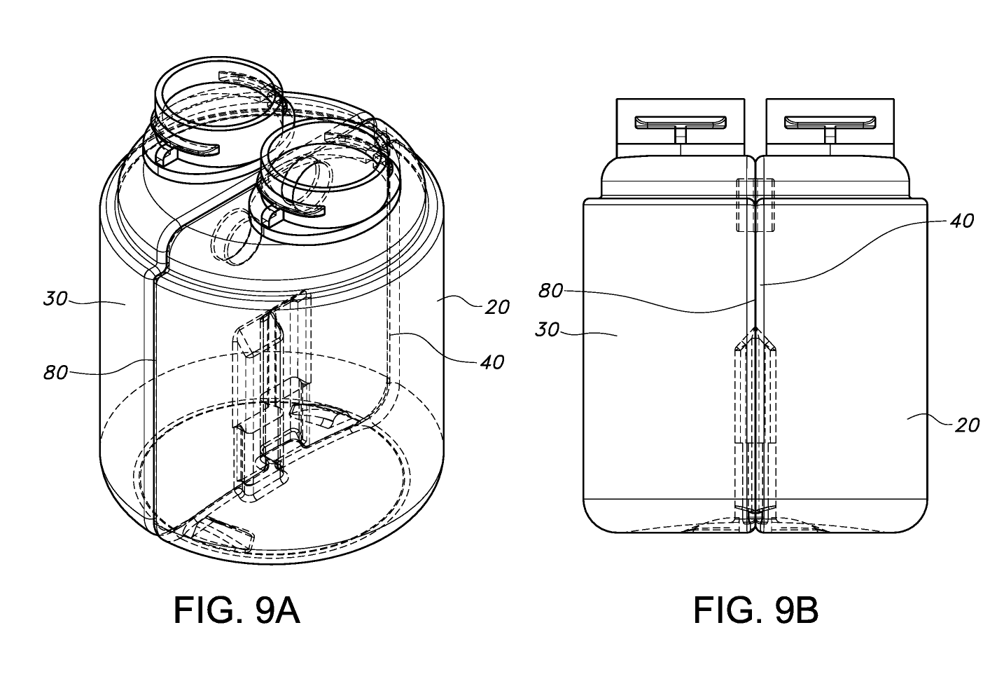

Referring to FIGS. 3, 6, 7, 8, 9A and 9B, the back 40 of one bottle, namely bottle 20 is shown. As discussed above, the bottles 20, 30 are identical. Thus, the back 40 of bottle 20 and the back 80 of bottle 30 are identical structures and have the same interlock connection systems including the first 50 and second 60 interlock connection. Accordingly, the discussion applies to the back of each bottle 20, 30.

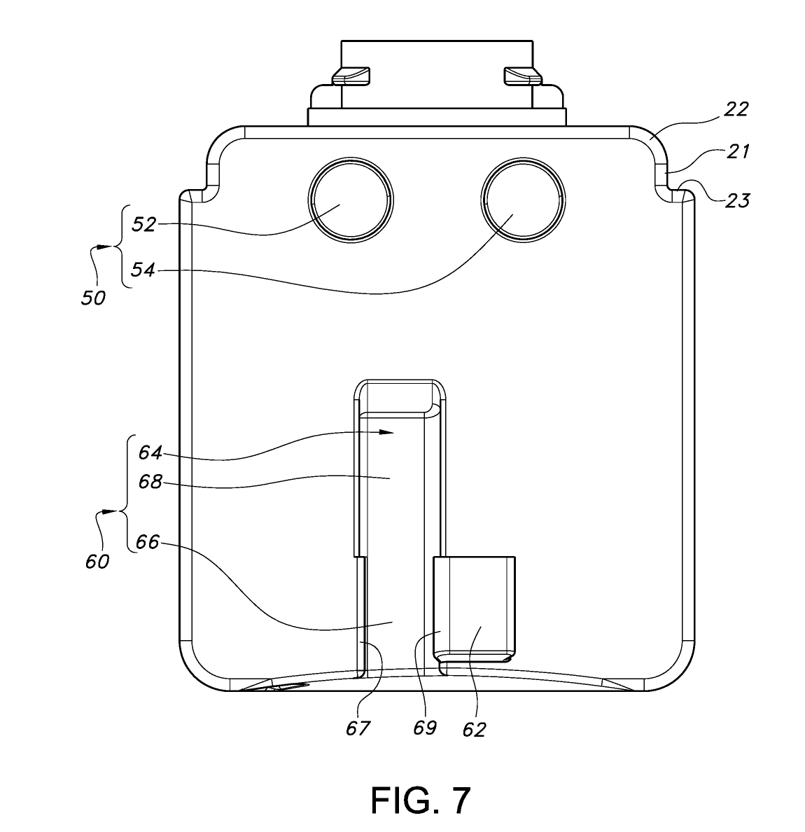

Referring to the back 40 of bottle 20, back 40 has a first interlock connection or connection subassembly 50, and second interlock connection or connection subassembly 60 that together comprise the interlock connection assembly. The first interlock connection 50 is positioned near the top 22 of bottle 20. As shown in the embodiment of FIG. 7, top 22 of bottle 20 has a shoulder 21 and a flat surface 23. In a preferred embodiment, the first interlock connection 50 is positioned so that one half of the connection 50 is above the flat surface 23 and one-half below the flat surface 23. While the button 54 and button receiver 52 of the first interlock connection 50 can be positioned anywhere along the back 40, to avoid the use of a second or more extended vertical slot 64, the first interlock connection should be in top half of the back 40 and the second interlock connection 60 should be in bottom half of the back, or vice versa. Specifically, those skilled in the art will recognize that the first interlock connection 50 may be provided at a bottom half of the bottle and the second interlock connection 60 may be provided at a top half of the bottle. More preferably, the second interlock connection 60 should be at or close to the bottom 26 of the bottle 20. Most preferably, when the second interlock connection 60 is provided at or close to the bottom 26 of the bottle 20, the first interlock connection 20 is preferably positioned at or towards top 22 in order to optimize the stability of the two bottles by providing an interlock connection at the top and bottom of the connection assembly. This optimization is significant since it provides better control for filling of the bottles since the filing line receives the bottles in accurate alignment. Further, positioning the second interlock connection 60 at or close to the bottom 26 of the bottle 20 while the first interlock connection 20 is positioned at or towards top 22, such an arrangement provides for an easier disassembly of the bottles 20, 30, such as after filling or for replacement of one or both of the bottles.

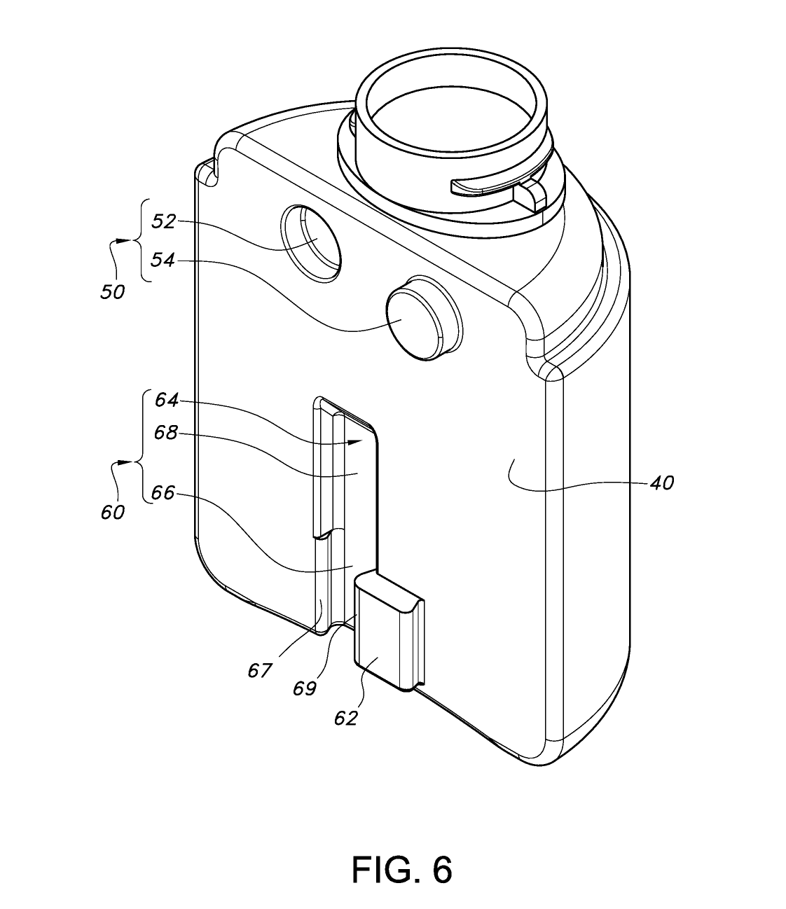

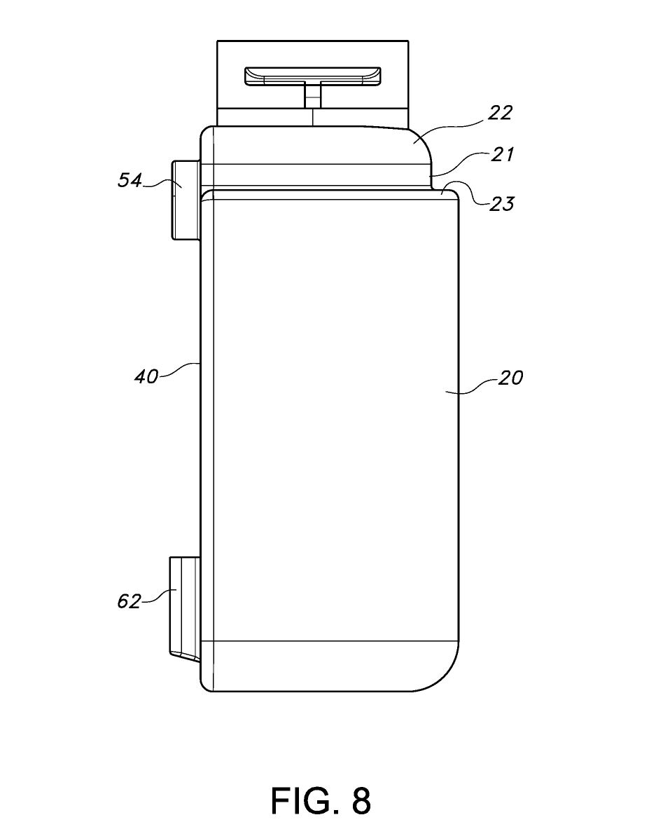

First interlock connection means 50 comprises a female inset or button receiver 52 and a male protuberance or button 54. The protuberance 54 and correspondingly shaped receiver 52 may take any geometry. For example, the geometry may be a circle, a half-circle, a square, a pentagon, a hexagon, an octagonal, a triangle or any other known geometry. As shown in FIGS. 6 and 8, a circular button 54 extends from the back 40 of bottle 20 about 0.03 inches to about 0.100 inches. This amount corresponds to the depth of the correspondingly shaped circular button receiver 52 of bottle 30. Thus, the button 54 of the first bottle 20 will be received in the button receiver 52 of the second bottle 30, and the button receiver 52 of the first bottle 20 will receive the button 54 of the second bottle 30. The buttons 54 are frictionally engaged with the button receivers 52 to provide a firm engagement yet still allow the engagement to be separated and reconnected repeatedly. The first interlock connection means 50 prevents the bottles from being displaced in the y-direction and allows for separation of the bottles in the x-direction.

Second interlock connection means 60 of bottle 20 is positioned close to but slightly spaced from the bottom 26 of bottle 20. Second interlock connection means 60 preferably comprises a dovetail connection, although any interlocking shape may be used as will be known to those skilled in the art. The second interlock dovetail connection means 60 preferably includes a substantially rectangular shaped projection 62 and a correspondingly shaped elongated vertical slot 64 to receive the projection 62. As with the first interlock connection means 50, the second interlock connection means 60 of bottle 20 mates with the mirror image second interlock connection means 60 of bottle 30 as shown in FIGS. 3 and 5.

The rectangular shaped projection 62 extends from back 40 of bottle 20 about 0.04 inches to about 0.2 inches. Rectangular shaped projection 62 is about 0.25 inches to about 0.75 inches in the x direction and about 0.10 inches to about 0.50 inches in the y direction.

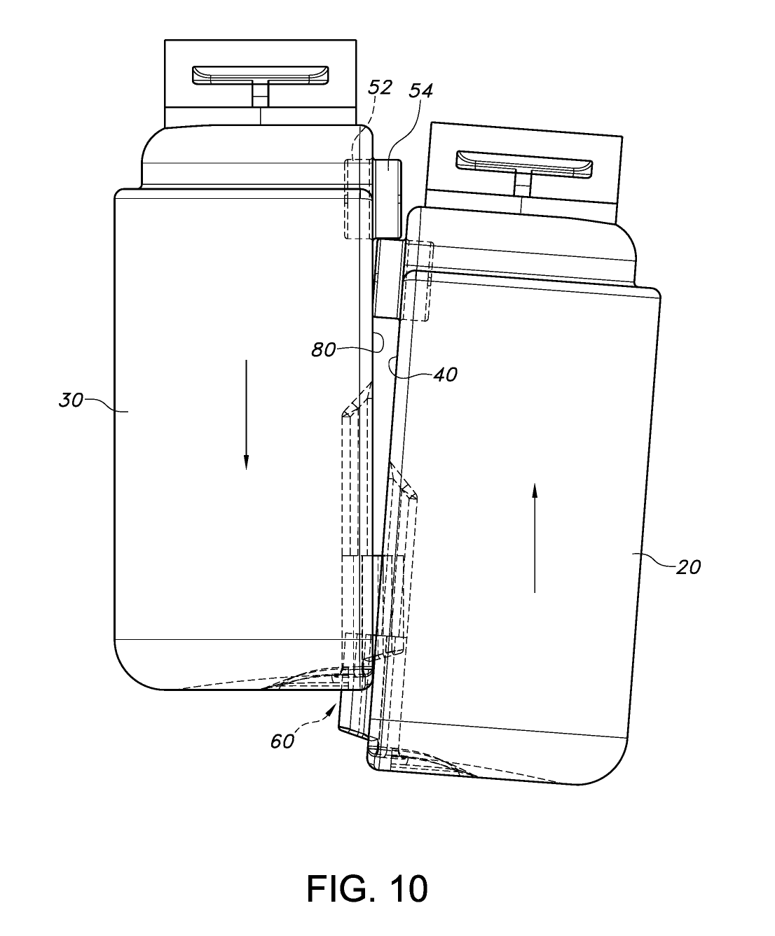

Elongated vertical slot 64 has two portions. A first portion 68 is a larger top portion of the slot 64. The second lower portion 66 has a narrower width (or x direction). The first portion 68 is adapted to easily receive the protuberance 62 in the second interlock connection of bottle 30 without excess frictional engagement. The first portion 68 provides a guide section to align the two bottles 20, 30 for sliding engagement when the bottles are moved in an upward/downward direction relative to one another as shown in FIG. 10. Thus, the bottles 20, 30 may be engaged by moving one bottle from a position lower than the other, in a direction upwards to until the buttons 54 and button receivers 52 align and engage each other, i.e., a slide and snap assembly process. Further upward movement would allow disengagement of the bottles by moving the projection 62 into the larger portion 68 of the slot 64. Thus, first portion 68 has a width that is about 0.101 inches to about 0.501 inches, which is larger than the dimensions of the projection 62. The second portion 66 can also receive the projection 62; however, when it is received in the lower portion 66 of the slot a snug fit by frictional engagement is provided. As shown in FIG. 6, second lower portion 66 preferably includes a dovetail shape formed by a first overhang 67 on one side and second overhang 69 on the projection 62. Thus, second portion 66 has a width that is about 0.10 inches to about 0.50 inches in order to have the snug fit with the projection 62. Those skilled in the art will appreciate that any interlocking geometry may be used to form the slot and projection such as a circular, T-shaped or L-shaped geometry as shown in German Patent No. DE 20218244.

As shown in FIG. 10, the second interlocking connection means 60 which provides sliding engagement includes enough play or flexibility to allow the first interlocking connection means 50, such as buttons 54, to slide along a back of the bottle until aligned with the button receivers 52. This play or flexibility allows the second interlocking connection means 60 to be partially engaged prior to the first interlocking connection means 50 becoming engaged to connect the bottles together. Likewise, the play or flexibility of the second connection means 60 allows the first interlock connection means 50 to be disengaged while the second interlocking connection remains engaged to allow disassembly of the sliding second interlock connection means 60 for refilling and/or replacement of one or both of the bottles.

The second interlock connection means 60 between the two bottles 20, 30 if used alone could disassemble from the pump head when accidentally dropped. In particular, if one of the two bottles 20, 30 strikes a hard surface, that bottle may axially slide or move in along the y axis to disengage from the pump head and the other bottle. To the contrary, in the present invention, the first interlock connection means 50 prevents y axis relative movement of the bottles and thus prevents disengagement of the two bottles from the pump head so that the two bottles will remain assembled even if accidentally dropped. Likewise, the first interlock connection means 50 can pull apart or split from each other, if it were the only interlock connection provided, and thus dissemble the two bottles 20, 30 when connected to the pump head if it were not for the addition of the second interlock connection means 60. Thus, the present invention has discovered that the two bottles 20, 30 once assembled using the combination of the first interlock connection means 50 and second interlock connection means 60 and being held together by the pump head, cannot disassemble accidentally should the unit be dropped. This is so even if a bottle strikes a surface that would otherwise cause the bottle to slide along the y axis since the first interlock connection means 50 prevents such separation. Likewise, the bottles 20, 30 cannot separate accidentally in the horizontal or x axis direction since the second interlock connection means 60 in combination with the first interlock connection 50 overcomes such accidental horizontal forces and prevents such separation. Thus, due to the different structures of the first and second interlock connections 50 and 60, respectively, and the structure of each connection to minimize separation by one of two different possible separation forces in both the x and y directions, it has been found that the slide and snap bottle interlock system of the present invention overcomes virtually all unintended or accidental disengagement and, moreover, provides a steadier alignment of the two bottles 20, 30 throughout the filling and/or replacement process.

Accordingly, the present invention provides superior retention to hold the two bottles together, without the reliance on additional components such as label wrap or base cap, and improved alignment of the two bottles once assembled, yet still proved suitable for replacement of each bottle or bottle halves.

Also, the interlock connections of the present invention as discussed above, facilitates the filling of bottles. The prior filling operations required filling a single bottle at a time in an unconnected state, which is clearly more costly for operations. Alternatively, the prior filling of connected or joined bottles required the temporary use of other means, such as a custom fixture or a bottle wrap to keep the bottles from accidentally separating during the process. Again, the use of such temporary custom fixtures or bottle wrap increased the cost of operations, and also did not assure sufficient alignment unless the custom fixture was correctly designed and applied or, likewise, the bottle wrap was properly applied. Also, the bottle wrap, besides creating an ease of use that is not appreciated by a customer, creates an environmental problem especially for replacement of a bottle since the wrap must be removed and discarded. Once removed, the bottles had a tendency to become separated even if not desired. Thus, the combination connection system of the present invention overcomes the prior shortcomings in keeping the bottles connected, but allows them to be separated and reconnected, as desired.

Another benefit of the present disclosure is that due to the alignment of the two bottles for filling and during movement before and after filling, there are more options and flexibility to decorate the bottles. For example, the bottles can be screen printed together in an assembled state.

Also, the present interlock connections has an additional beneficial. The interlock connection system of the present invention allows the consumer to replace one or both of the bottles so that the pump can reused. Thus, the consumer can easily refill or replace one or both bottles due to the flexibility provided by the dual interlock connections of the present invention.

FIG. 11 is an exploded view of the interlocking bottles and a pump mechanism to dispense products from the bottles. In a preferred embodiment, the pump mechanism is a variable mixing dispenser. For example, the pump mechanism can be set to provide equal amounts from each bottle, 50/50 or can be set at predefined variable increments such as 30/70 or even 100/0. Such a pump mechanism is currently being manufactured and sold by the Applicant, VariBlend Dual Dispensing Systems LLC. As shown in FIG. 11, the pump mechanism 100 includes a cap 110, a dispensing head 112, a proportional disc 114, a base 116 adapted to be removably mounted to the openings of the bottles 20, 30 and a dip tube assembly 118.

FIG. 12 illustrates the components shown in FIG. 11 in a fully assembled state. As discussed above, should it be desired to replace one or both of the bottles and/or refill a bottle, the pump mechanism 100 which holds the bottles in an assembled state is also adapted to be removed from the bottles. Once the pump mechanism is removed, the bottles can be separated by disengaging the first interlocking connection means 50 such as by pulling the buttons 54 out of the button receiver 52 and subsequently sliding the bottles relative to one another to disengage the second interlocking connection means 60. Upon refilling and/or replacement of a bottle, the bottles may be rejoined and the pump mechanism may be remounted onto the bottles. Thus, the present invention provides a unique arrangement of interlocking bottles which keeps the bottles joined and aligned for filling and prevents undesired separation of the assembly should the dispenser be accidently dropped and still permits the assembly to be disassembled for replacement or refilling of one or both of the bottles.

While the present disclosure has been described with reference to one or more exemplary embodiments, it will be understood by those skilled in the art that various changes can be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the present disclosure.

What is claimed is:

1. A container interlock system comprising:
a first and second container, each of the first and second container including a back surface;
each of the first and second containers back surface including a first sliding interlock connection provided at one of the bottom and top half of the container, the first sliding interlock connection including at least one projection and at least one slot adapted to receive the projection and second interlock connection provided at a half of the container opposite the first sliding interlock connection, the second interlock connection including at least one protuberance and at least one correspondingly shaped receiver;
wherein the first and second containers are separably connected together by first slidingly engaging the first sliding interlock connection along a longitudinal axis such that the protuberances on the first and second containers slide along the back surfaces of the containers until aligned with the receiver on the other container for engagement therewith thereby providing two different interlock connections which resist separation in both the x and y directions.

2. The container interlock system of claim 1, wherein the at least one slot comprises an upper portion which is adapted to receive and guide the at least one projection and a lower portion having a complementary shape to the projection to frictionally engage and retain the at least one projection in the lower portion of the at least one slot.

3. The container interlock system of claim 1, wherein the protuberance of the second interlock connection comprises a geometric shape and the containers comprise substantially the same geometric shape to frictionally engage and retain the protuberance therein.

4. The container interlock system of claim 1, wherein the protuberance geometry comprises one of a circle, a half-circle, a square, a pentagon, a hexagon, an octagon or a triangle.

5. The container interlock system of claim 1, wherein the first and second containers are identical in structure.

6. The container interlock system of claim 1, wherein the first and second containers include an opening in the top thereof adapted to removably receive a pump mechanism.

7. The container interlock system of claim 1, wherein the first and second containers comprise a semicircular configuration.

8. The container interlock system of claim 1, wherein the first sliding interlock connection is provided adjacent to a bottom surface of the container and the second interlock connection is provided at a top half of the container.

9. The container interlock system of claim 8, wherein the first sliding interlock connection at the bottom of the container allows the containers to separate at an upper end when the sliding interlock connection is engaged to permit the at least one protuberance to slide along the surface of the opposite container until aligned with the at least one receiver.

10. The container interlock system of claim 1, wherein the first sliding interlock connection prevents the containers from separating along the x-axis when engaged and the second interlock connection prevents the bottles from sliding along the y-axis when engaged.

11. A container interlock system comprising:
a first and second container, each of the first and second container including a back surface, the first and second containers having identical structure provided on the back surface;
a first interlocking connection means provided on the back surface for separably holding the first and second containers together, the first interlocking connection means engageable by sliding the first container relative to the second container;
a second interlocking connection means provided on the back surface for separably holding the first and second containers together, the second interlocking connection means engageable by fitting at least one protuberance into at least one correspondingly shaped recess adapted to receive the at least one protuberance;
wherein the first interlocking connection means prevents separation of the containers along an x-axis and the second interlocking connection means prevents sliding of the containers relative to each other along an y-axis.

12. The container interlock system of claim 11, wherein the first interlocking connection means comprises a projection adapted to slidingly engage a correspondingly shaped slot.

13. The container interlock system of claim 12, wherein the projection is dovetail-shaped and the slot includes a dovetail-shaped slot to receive the dovetail-shaped projection.

14. The container interlock system of claim 11, wherein the second interlock connection means comprises a button having a geometric shape and a correspondingly shaped recess adapted to receive the button.

15. The container interlock system of claim 11, wherein the first interlock connection means is provided on one of the upper and lower half of the back surface and the second interlock connection means is provided on the opposite half of the back surface from the first interlock connection means.

16. The container interlock system of claim 11, wherein the first interlock connection means and second interlock connection means are adapted to be engageable and separable to allow replacement of one or both the first and second containers.

17. The container interlock system of claim 11, wherein the first and second containers include an opening in the top thereof adapted to removably receive a pump mechanism.

18. The container interlock system of claim 17, wherein the pump mechanism is a variable ratio dispenser for mixing products filled in the containers.

19. The container interlock system of claim 11, wherein the first sliding interlock connection is provided adjacent to a bottom surface of the container and the second interlock connection is provided at a top half of the container.

20. The container interlock system of claim 19, wherein the first sliding interlock connection at the bottom of the container allows the containers to separate at an upper end when the sliding interlock connection is engaged to permit the at least one protuberance to slide along the back surface of the opposite container until aligned with the at least one recess.
